(19) United States
(12) Patent Application Publication
(10) Pub. No.: US 2013/0262262 A1
(43) Pub. Date: Oct. 3, 2013

(54) Consumer Alerts from a Readable Code

(71) Applicant: Keren Aminia, Los Angeles, CA (US)

(72) Inventor: Keren Aminia, Los Angeles, CA (US)

(73) Assignee: eBay, Inc., San Jose, CA (US)

(21) Appl. No.: 13/433,692

(22) Filed: Mar. 29, 2012

(51) Int. Cl. G06Q 30/00; G06F 17/30

(52) U.S. Cl. 705/26.7; 235/375

(57) ABSTRACT

Systems and methods are provided for consumer alerts from a readable code according to one or more embodiments. According to an embodiment, a method comprises receiving, electronically by a processor of a service provider, information about a product included in a readable code, wherein the information is received from a reading of the code from a user device. The method also comprises receiving, by the processor, information about a user. The method also comprises determining positive or negative criteria or preferences of the user. And the method further comprises providing, to the user device, an alert about the product based on the positive or negative criteria or preferences of the user.

### BACKGROUND

1. Technical Field

Embodiments of the present disclosure generally relate to product information, and more particularly, to methods and systems for obtaining information from a product readable code.

2. Related Art

Transactions such as in-person purchases at a point of sale (POS) location generally involve a consumer having to read all information on product labels to find pertinent information about the product. For example, a consumer that is allergic to a certain food ingredient generally has to read an entire label on a food product to determine whether the ingredient is included in the food product. Having to read all or most of the pertinent product information, for example, all the ingredients of a food product, makes for a purchasing experience that may be inefficient and inconvenient for the consumer.

Although consumers may be able to read all or most of the information about a product in-person at a POS location, a need exists for improved methods and systems for a more efficient manner to obtain desired product information.

### SUMMARY

As will be further described herein in relation to one or more embodiments, methods and systems are provided for obtaining desired product information in an efficient manner.

In accordance with an embodiment of the disclosure, a method comprises receiving, electronically by a processor of a service provider, information about a product included in a readable code, wherein the information is received from a reading of the code from a user device. The method also comprises receiving, by the processor, information about a user. The method also comprises determining positive or negative criteria or preferences of the user. And the method further comprises providing, to the user device, an alert about the product based on the positive or negative criteria or preferences of the user.

In accordance with another embodiment of the disclosure, a system comprises a server at a remote location in communication with a server at a point of sale (POS) location and a user device over a network. The system also comprises one or more processors and one or more memories adapted to store a plurality of machine-readable instructions. When executed by the one or more processors, the machine-readable instructions are adapted to cause the system to receive, electronically by the server at the remote location, information about a product included in a readable code, wherein the information is received from a reading of the code from the user device; receive, by the server at the remote location, information about a user; determine positive or negative criteria or preferences of the user; and provide, to the user device, an alert about the product based on the positive or negative criteria or preferences of the user.

In accordance with another embodiment of the disclosure, a user device comprises an input interface. The user device also comprises one or more processors and one or more memories adapted to store a plurality of machine-readable instructions which when executed by the one or more processors are adapted to cause the user device to: read, via the input interface of the user device, contents in a readable code related to one or more products; and alert a user of the user device about the product(s) based on specific positive or negative preferences programmed by the user.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 is a flow diagram illustrating a method for providing consumer alerts from a readable code according to an embodiment of the present disclosure.

FIG. 2 is a block diagram illustrating a system for providing consumer alerts from a readable code according to an embodiment of the present disclosure.

FIG. 3 is a diagram illustrating a flow on a user device for consumer alerts from a readable code according to an embodiment of the present disclosure.

Like element numbers in different figures represent the same or similar elements.

### DETAILED DESCRIPTION

In accordance with one or more embodiments described herein, methods and systems are provided for obtaining desired product information from a user device-readable code. In one or more embodiments, users or customers at a POS location may use their user devices (e.g., their mobile devices) to scan product codes such as a QR code or a barcode to obtain desired information about the product. User device-readable codes may be displayed or printed on a product at a point of sale (POS) location, on an advertisement, a bulletin board, a website, a publication, or any other appropriate location. The readable codes may encode product or label information including, for example, ingredients in a food product, the country where the product was manufactured, whether the product is kosher, certified organic, product recalls, or any other pertinent information about the product. The user device may be configured to scan for specific desired information based on a user's criteria, preferences, settings or restrictions, for example, to avoid allergies, to identify kosher products, to identify products made in the U.S.A., etc. Consumer alerts may be provided based on the customers' preferences or criteria. For example, a customer that is allergic to peanuts, may be alerted that the product contains peanuts as an ingredient.

Currently, to find specific information about a product, for example to find kosher products, a consumer generally has to read all or most of the ingredients of the product to look for the one or two ingredients that may be off limits. According to embodiments herein, the consumer may program into his or her user device the specific ingredients to identify. The consumer may use the user device to scan the readable code, which in turn may return an indication of, for example: “YES, the product is kosher,” or “NO, the product is not kosher because . . . .” In other examples, the consumer may look for ingredients indicating gluten, sucrose, nuts, or other ingredients. In further examples, the consumer may look for indications of fat content, salt content, calories, preservatives, other allergens and/or the like.

In that regard, according to one or more embodiments, the consumer may be alerted in relation to positive or negative preferences or criteria. For example, in relation to a positive preference or criteria, a user may indicate a preference for kosher products. Upon reading a product code, it may be determined that the product is kosher, so the user may be alerted that the product is indeed kosher. In another example, the user may have indicated a preference for products made in the U.S.A. Upon reading a product code, it may be determined that the product is made in the U.S.A., for example, by looking for a catch phrase such as “Made in USA”. The user may then be alerted that the product is made in the USA as desired. In relation to a negative preference or criteria, a user may have indicated a preference for products that do not contain peanuts perhaps due to an allergy. Upon reading a product code, it may determined that the product has peanuts so the user may be alerted to the presence of peanuts as an ingredient in the product. Advantageously, the consumer does not have to read everything about the product, for example, on a label, but may be alerted in connection with a positive or negative preference or criteria (e.g., only kosher foods, made in USA, no peanuts, etc.).

In various embodiments, as information is read or scanned from a readable code, the consumer may find that a specific product may not meet the desired preferences, characteristics, restrictions or criteria. For example, a consumer that may only wish to purchase clothing made in the USA, may find that a particular clothing item is made in China. This information may be conveyed to a seller such as a store or a marketplace such as eBay® and as a result, recommendations may be provided to the consumer for alternate products that may be of interest to the consumer based on the consumer's applicable positive or negative preferences. For example, recommendations for clothing items that are made in the USA may be provided. As such, embodiments herein may provide methods and systems that go beyond label information and recommendations may be made for alternate products that may meet the customer's preferences or criteria.

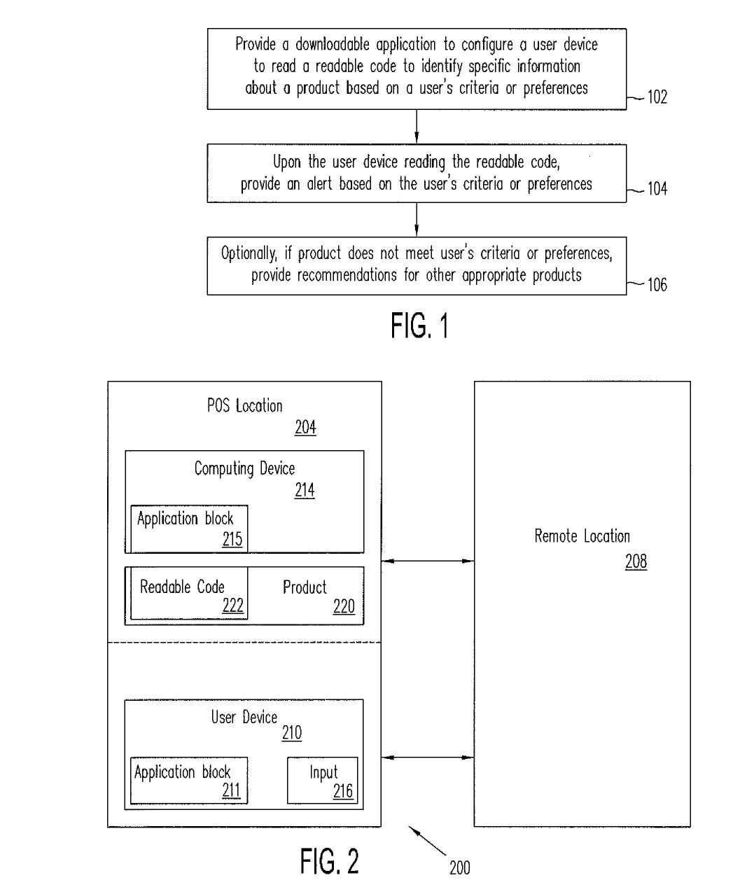

Referring now to the drawings wherein the showings are for purposes of illustrating embodiments of the present disclosure only, and not for purposes of limiting the same, FIG. 1 is a flow diagram illustrating a method for providing consumer alerts from a readable code according to an embodiment of the present disclosure.

In block 102, a user may download an application on a user device to configure the user device to read a scannable or readable code to identify specific information about a product based on a user's criteria or preferences. The readable code may be encoded to include information about a product or package. The readable code may be, for example, a user device readable QR code or a barcode. For example, the readable code may encode ingredients of a food product, where the product was manufactured, whether the produce is kosher or any other suitable information about the product. In other embodiments, a readable code may be provided on restaurants menus or the like.

The user may program into his or her user device specific information to identify certain criteria or preferences for a product. For example, the user may configure the application to identify specific ingredients to which the user may be allergic such as peanuts. In other examples, the user may configure the application to identify a product's fat content, calories, whether the product is kosher, or any other appropriate restrictions, settings, criteria or preferences.

In block 104, upon the user reading or scanning the readable code with the user device, an alert may be provided based on the user's criteria or preferences.

In one embodiment, upon scanning or reading a product code with a user device having a downloaded application, the application may filter ingredients of the product, rather than showing the actual ingredients. As such, the user is alerted based on a user's setting, preference or criteria, for example, a peanut allergy, high sodium content, pork content, recycled product, whether the product is recyclable; whether the produce is made in the USA, consumer product ratings, nutritional value, packaging material, whether manufacturer is a certified company, e.g., no child labor, not tested on animals, all natural ingredients, certified organic, kosher, no health department issues, health alerts or recalls for a specific product, child-safe, age rating, expiration date, alcohol amount, parental control to notify parent of scanning a restricted item and/or bar purchase from the user device and/or any other appropriate settings or preferences or criteria. In other embodiments, the consumer may also be alerted that the product is clear or meets the consumer's preferences or criteria. The alerts may be both positive or negative.

In this regard, some of the settings may have to go through a database or other system, such as a certification list, a recommendation engine such as provided by eBay of San Jose, Calif., etc. Other settings may be self-contained in the readable code.

Optionally, in block 106, upon scanning the readable code, if there is an alert or an indication that the product does not meet the user's criteria or preferences, alternatives may be suggested to the alerted products. For example, a low sodium potato chip may be recommended as an alternative to a high-sodium potato chip. In various embodiments, the recommendations may be made either for the same seller (in a physical location or online) or for any other sellers. In some instances the recommendations may lead to other sellers having products that may then be purchased online.

In one or more embodiments, sellers may be provided with data of what consumers are scanning. In other embodiments revenue may be obtained from the sellers to subscribe and/or sell the application.

Furthermore, marketing may be directed to consumers based on user set preferences, criteria or restrictions. For example, if a user has a preference for jeans made in the USA, then marketing may be targeted for that user for different kinds of jeans or other clothing or products all made in the USA.

Referring now to FIG. 2, a block diagram illustrates a system for providing consumer alerts from a readable code according to an embodiment of the present disclosure. In one or more embodiments, the method illustrated in the embodiment of FIG. 1 may be implemented by the system illustrated in the embodiment of FIG. 2.

In system 200, a remote location 208 may interact with a POS location 204 having a computing device 214 and with a user having a user device 210. In one or more embodiments, a seller at POS location 204 may offer a readable code 222 such as a QR code on a product 220 or displayed or printed on an appropriate location such that a consumer may read or scan the readable code 222 with user device 210 to identify information about product 220. The readable code 222 may include label information such as ingredients for food packages. The consumer may configure user device 210 to scan for specific items, for example, to avoid allergy, non-kosher products, etc.

Remote location 208 may include a service provider such as PayPal, Inc. or eBay, Inc. of San Jose, Calif., or one or more other institutions, or a respective intermediary that may facilitate transaction or other routings between users at multiple POS locations or, for example, financial institutions. Remote location 208 may include a server and maintain data or information related to, for example, product information, account information, passwords, PINs, passcodes, seller or terminal identifiers, and/or user device information such as user device identifiers or user transaction data. For example, an identifier associated with a seller may be associated with an account number or a name or a POS location identifier. A password may also be associated with a unique account or with a unique user device (having multiple accounts). Data or information may be stored according to various schemes for coordinating accounts, passwords, PINs or passcodes, user devices and seller information.

POS location 204 may be any physical location for conducting business (profit or non-profit) by a seller such as a merchant or service provider including, for example, a restaurant, a retail store, a service facility such as a gym, a spa, an office, or any other type of business that provides goods and/or services. Alternatively, a user may self operate at the POS location 104, for example, at vending machines, ATMs, laundromats, ticket dispensers, to-go menus, etc. Other than providing readable codes on products themselves, it should be appreciated that sellers may provide customers with appropriate readable codes in many different ways including, for example, a customer check, a table, a tip tray or the like. Also, the seller may provide the readable code to a customer as part of a larger display such as a menu, a bulletin board, or an electronic display, which may be found at POS location 204. In other embodiments, sellers may provide the readable codes to customers conspicuously placed or fastened to self-operated machines. In further embodiments, device-readable codes may be displayed or printed on an advertisement, a website, a publication (e.g., a magazine), or any other appropriate location.

Computing device 214 at POS location 204 may be implemented using any appropriate combination of hardware and/or software configured for wired and/or wireless communication over a network. For example, computing device 214 may be implemented as a personal computer, a notebook computer, a personal digital assistant (PDA), a smart phone, and/or other types of computing devices, which may be in communication with the Internet or another network.

User device 210 may be implemented using any appropriate combination of hardware and/or software configured for wired and/or wireless communication over a network. For example, user device 210 may be implemented as a wireless device, e.g., a wireless telephone, a personal digital assistant (PDA), a smart phone, a key fob, a smart card, a notebook computer and/or other types of mobile computing devices, which may be in communication with the Internet or another network.

User device 210 may include an Application component or block 211 (Application block) where applications may be loaded. In an embodiment, Application block 211 may include a downloaded application, for example, from remote location 208, to configure user device 210 to read or scan readable codes to identify specific information about one or more products offered at POS location 204. In that regard, readable codes may be read via an input interface 216 of user device 210. It should be appreciated that input interface 216 of user device 210 illustrated in this embodiment may be adapted to enter data such as any information related to a product. For example, in various embodiments, input interface 216 on user device 210 may include a code reader or scanner (e.g., for reading a QR code), a magnetic stripe reader, an RFID chip, Bluetooth, an NFC transponder, an IR communications reader, etc. in order to enter data.

In one or more embodiments, user device 210 may have a digital signature particular to user device 210. Application block 211 may also include other pre-loaded applications, for example, a payment service provider application to facilitate financial transactions. In addition, user device 210 may include various applications as may be desired in particular embodiments to provide desired features to user device 210.

User device 210, remote location 208, for example a service provider, as well as computing device 214 located at POS location 204 may each include one or more processors, memories, and other appropriate components for executing instructions such as program code and/or data stored on one or more computer readable mediums to implement the various applications, data, and methods described herein. For example, such instructions may be stored in one or more computer readable storage mediums such as memories or data storage devices internal and/or external to various components of the system, and/or accessible over a network, which may be implemented as a single network or a combination of multiple networks. For example, in various embodiments, a network may include the Internet or one or more intranets, landline networks, wireless networks, and/or other appropriate types of networks.

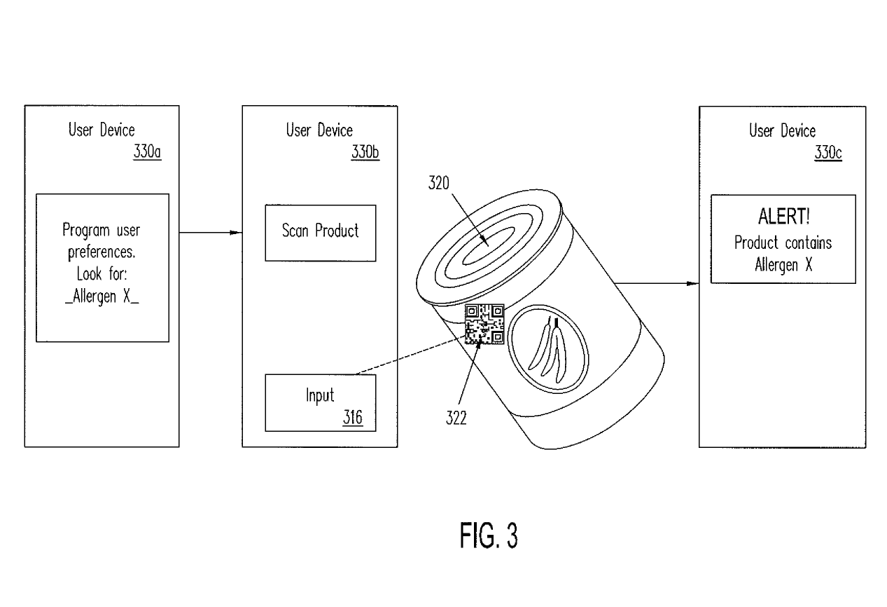

Referring now to FIG. 3, a diagram illustrates a flow on a user device for consumer alerts from a readable code according to an embodiment of the present disclosure.

In embodiments herein, a user device may have a downloaded application from a remote location such that a user may configure or program the user device to scan or look for specific information about products based on certain user preferences or criteria. In view 330a of FIG. 3, according to an embodiment, a user may program his or her user device to scan for or look for “Allergen X” in products. It should be understood that the user may program his or her user device to scan products based on many different positive or negative preferences or criteria as described above according to one or more embodiments.

Sellers may provide readable codes or any form of content, for example, QR codes, barcodes, chips, RFID, magnetic stripes, etc., positioned directly on products, or located on any appropriate locations to display the readable codes or forms of content. In an embodiment, users, if they wish, may walk up to a product and read the readable code with a user device. In view 330b, a seller may offer a product 320 having a user device-readable code 322 such as a QR code displayed or printed on product 320. The user may scan the readable code 322 displayed or printed on product 320 via an input interface 316 of the user device that is adapted to read the readable code 322. As described above, it should be noted that the readable code may be any feasible code that may be read or scanned by a user device or may be in any form of content and may include, for example, an image. In this embodiment, readable code 322 is a QR code.

The readable code 322 may be encoded or embedded with any information related to product 320, for example, the information may include ingredients, calories, fat content, sodium content, organic and/or any other information appropriate for food label information. In addition, the readable code 322 may be linked or mapped to a database in a remote location that maintains further information about the product such as manufacturer information. In one or more embodiments, product information may be kept in the remote database and may be either dynamic information, for example, recalls, etc., or it may be information that requires certification by a third party, for example, certified organic, certified no child labor facility, etc.

Upon obtaining information about a product via reading or scanning the readable code, the user may be alerted based on the user's programmed positive or negative criteria or preferences. In view 330c, an alert is provided that product 320 contains “Allergen X”. It should be noted that any appropriate label or phrase may be used to alert the user of the presence of Allergen X, or whether the product meets the user's programmed criteria or preferences.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although embodiments related to consumer product information have been described, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A method comprising:
receiving, electronically by a processor of a service provider, information about a product included in a readable code, wherein the information is received from a reading of the code from a user device;
receiving, by the processor, information about a user;
determining positive or negative criteria or preferences of the user; and
providing, to the user device, an alert about the product based on the positive or negative criteria or preferences of the user.

2. The method of claim 1, further comprising recommending other products or sellers to the user if the product does not meet the user's positive or negative criteria or preferences.

3. The method of claim 1, wherein the information about the product comprises specific ingredients in a food product.

4. The method of claim 1, wherein the information about the product comprises specific catch phrases.

5. The method of claim 1, wherein the readable code is provided to the user on a product comprising a code adapted to be scanned by an input of the user device.

6. The method of claim 1, wherein the readable code further comprises a QR code or a barcode printed or displayed on the product, at a point of sale (PUS) location, on a self-operated machine, on an advertisement, on a website, on a publication, and/or on a menu.

7. The method of claim 1, further comprising making recommendations for alternate products and/or sellers based on the positive or negative criteria or preferences.

8. The method of claim 1, further comprising accessing a database including information about the product.

9. The method of claim 8, wherein the database further comprises a certification list or a recommendation engine.

10. The method of claim 1, further comprising providing sellers with data related to what the user device is reading.

11. The method of claim 10, further comprising obtaining revenue from the sellers, wherein the sellers subscribe and/or sell an application downloadable on the user device.

12. The method of claim 1, further comprising providing sellers with data related to the user's positive or negative criteria or preferences so that marketing may be directed to the user based on the criteria or preferences.

13. A system comprising:
a server at a remote location in communication with a server at a point of sale (POS) location and a user device over a network;
one or more processors; and
one or more memories adapted to store a plurality of machine-readable instructions which when executed by the one or more processors are adapted to cause the system to:
receive, electronically by the server at the remote location, information about a product included in a readable code, wherein the information is received from a reading of the code from the user device;
receive, by the server at the remote location, information about a user;
determine positive or negative criteria or preferences of the user; and
provide, to the user device, an alert about the product based on the positive or negative criteria or preferences of the user.

14. The system of claim 13, wherein the plurality of machine-readable instructions are further adapted to cause the system to recommend alternate products to the user if the product do not meet the user's positive or negative criteria or preferences.

15. The system of claim 13, wherein the plurality of machine-readable instructions are further adapted to cause the system to provide sellers of the product with data related to the user's positive or negative criteria or preferences so that marketing may be directed to the user based on the criteria or preferences.

16. The system of claim 13, wherein the remote location further comprises a service provider, a financial institution or a respective intermediary adapted to facilitate transactions or routings between users at multiple POS locations and the remote location.

17. A user device comprising:
an input interface;
one or more processors; and
one or more memories adapted to store a plurality of machine-readable instructions which when executed by the one or more processors are adapted to cause the user device to:
read, via the input interface of the user device, contents in a readable code related to one or more products; and
alert a user of the user device about the product(s) based on specific positive or negative preferences programmed by the user.

18. The device of claim 17, wherein the plurality of machine-readable instructions which when executed by the one or more processors are further adapted to cause the user device to recommend alternate products based on the positive or negative based preferences configured by the user device.

19. The device of claim 17, wherein the plurality of machine-readable instructions which when executed by the one or more processors are further adapted to cause the user device to configure the user device to scan for specific ingredients in food products or to scan for specific catch phrases.

20. The device of claim 17, wherein the input interface comprises a touch screen, a code reader or scanner, a magnetic stripe reader, an RFID chip, an NFC transponder, Bluetooth, and/or a IR communications reader for reading the contents of the readable code.
